(19) United States
(12) Patent Application Publication
(10) Pub. No.: US 2026/0149006 A1
(43) Pub. Date: May 28, 2026

(54) TRIPLE CORE-SHELL CATALYST COMPLEX FOR ELECTROCHEMICAL DEVICE AND METHOD OF MANUFACTURING SAME

(71) Applicants: Hyundai Motor Company, Seoul (KR); Kia Corporation, Seoul (KR)

(72) Inventors: Junu Bak, Hwaseong (KR); Jun Seog Park, Hwaseong (KR)

(21) Appl. No.: 19/380,689

(22) Filed: Nov. 5, 2025

(30) Foreign Application Priority Data
Nov. 22, 2024 (KR) 10-2024-0168621

(51) Int. Cl. H01M 4/86; C23C 18/16; C23C 18/44; C25B 11/054; C25B 11/065; C25B 11/097; H01M 4/92

(52) U.S. Cl. CPC H01M 4/8657; C23C 18/1637; C23C 18/165; C23C 18/1692; C23C 18/44; C25B 11/054; C25B 11/065; C25B 11/097; H01M 4/921; H01M 4/926

(57) ABSTRACT

A triple core-shell catalyst complex for electrochemical devices features a core of Pt and a first heterometal (M₁), a first shell containing Pt and a second heterometal (M₂), and a second shell containing Pt. Method of making the catalyst involves forming the first shell by simultaneously reducing Pt and M₂, then removing M₂ at the outer surface to form a Pt-rich second shell, optionally followed by acid and heat treatments for stability.

### CROSS-REFERENCE TO RELATED APPLICATION

This application claims, under 35 U.S.C. § 119(a), the benefit of Korean Patent Application No. 10-2024-0168621, filed on Nov. 22, 2024, the entire contents of which are incorporated herein by reference.

### BACKGROUND

### Technical Field

The present disclosure relates to a triple core-shell catalyst complex for an electrochemical device and a method of manufacturing the same, in which a two-layer shell is formed on the surface of a core including a platinum alloy, whereby elution of a metal forming an alloy with platinum may be suppressed and durability of the catalyst may be improved.

### Background

An electrochemical device is a device that uses oxidation and reduction reactions and various phenomena resulting from the transfer of electrons between materials. A representative example thereof is a device based on fuel cell technology using a proton exchange membrane (PEM or polymer electrolyte membrane) and carbon dioxide reduction reaction (CO₂RR) technology for converting carbon dioxide into useful compounds by electrochemical reduction.

A proton exchange membrane fuel cell is a hydrogen-fueled power generator that offers high energy efficiency, a simple system configuration, and environmental friendliness. Proton exchange membrane fuel cells are attracting attention as energy-conversion devices for eco-friendly vehicles.

Reaction for power generation in a fuel cell occurs in a membrane-electrode assembly (MEA) including a perfluorinated sulfonic acid (PFSA) ionomer-based membrane and anode/cathode electrodes. After hydrogen is supplied to the anode, which is the oxidation electrode of the fuel cell, it dissociates into protons and electrons (hydrogen oxidation reaction (HOR)). The protons move through the membrane to the cathode (the reduction electrode) while the electrons move to the cathode through the external circuit. At the cathode, oxygen molecules, protons, and electrons react together to generate power and heat and produce water (H₂O) as a reaction byproduct (oxygen reduction reaction (ORR)).

As such, since oxygen reduction reaction occurring at the cathode is slower than hydrogen oxidation reaction, a larger quantity of catalyst is used at the cathode. The most widely used cathode material is a Pt/C catalyst complex in which platinum nanoparticles are supported on carbon. However, since a large amount of platinum is still used, there is a need for a method to further increase the oxygen reduction reaction activity. There is also a problem with elution of the transition metal during fuel cell operation, deteriorating durability.

It would be desirable to develop a new catalyst. It would be particularly desirable to have a new catalyst that maintains high activity and has improved durability.

### SUMMARY

The present disclosure has been made keeping in mind the problems encountered in the related art, and an example object of the present disclosure is to provide a catalyst having a core-shell structure in which a shell is formed on the surface of a platinum alloy catalyst, thereby exhibiting high oxygen reduction reaction activity and suppressing elution of a metal forming an alloy with platinum.

In some embodiments, the present disclosure provide a catalyst capable of more effectively suppressing elution of a metal during operation of a fuel cell, improving durability of the catalyst, and further improving performance and durability of the fuel cell, by performing acid treatment and heat treatment on the shell to form a multilayered shell.

The objects of the present disclosure are not limited to the foregoing. The objects of the present disclosure will be able to be clearly understood through the following description and to be realized by the means described in the claims and combinations thereof.

An embodiment of the present disclosure provides a triple core-shell catalyst complex for an electrochemical device, including a triple core-shell catalyst including a core portion (or simply a core) including an alloy catalyst (Pt-M₁) of platinum (Pt) and a first heterometal (M₁), a first shell portion (or simply a first shell) covering at least a portion of a surface of the core portion and including platinum (Pt) and a second heterometal (M₂), and a second shell portion (or a second shell) covering at least a portion of a surface of the first shell portion and including platinum (Pt).

In some embodiments, the triple core-shell catalyst complex may include support on which the triple core-shell catalyst is supported.

In some embodiments, the first heterometal (M₁) may include any one selected from the group consisting of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), bismuth (Bi), and combinations thereof.

In some embodiments, the second heterometal (M₂) may include any one selected from the group consisting of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), bismuth (Bi) and combinations thereof.

In some embodiments, the first heterometal (M₁) may include at least two different metallic elements (M₁₋₁, M₁₋₂, . . . ).

Here, the first heterometal (M₁) and the second heterometal (M₂) may include at least one metal element different from each other.

In some embodiments, an average particle diameter (D50) of the triple core-shell catalyst may be 3.5 nm to 6 nm.

In some embodiments, the thickness of the first shell portion may be 0.1 nm to 1 nm, and the thickness of the second shell portion may be 0.2 nm to 1.5 nm.

In some embodiments, the triple core-shell catalyst complex may include 0.1 to 50 wt % of the platinum (Pt) and 0.05 to 10 wt % of the first heterometal (M₁), based on a total weight of the triple core-shell catalyst complex.

In some embodiments, the triple core-shell catalyst complex may include 0.03 to 10 wt % of the second heterometal (M₂), based on a total weight of the triple core-shell catalyst complex.

In some embodiments, the second shell portion may be derived from the first shell portion.

In some embodiments, a catalyst comprises a core comprising an alloy catalyst (Pt-M₁) of platinum (Pt) and a first heterometal (M₁); an inner shell disposed on at least a portion of a surface of the core and comprising platinum (Pt) and a second heterometal (M₂); and a Pt outer shell disposed on at least a portion of a surface of the inner shell. The first heterometal (M₁) comprises any one selected from the group consisting of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), bismuth (Bi), and combinations thereof. The second heterometal (M₂) comprises any one selected from the group consisting of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), bismuth (Bi), and combinations thereof.

An average particle diameter (D50) of the catalyst may be about 3.5 nm to 6 nm, a thickness of the inner shell may be about 0.1 nm to 1 nm, and a thickness of the outer shell may be about 0.2 nm to 1.5 nm.

Another embodiment of the present disclosure provides a method of manufacturing a triple core-shell catalyst complex for an electrochemical device, including preparing a first mixture by adding an alloy catalyst (Pt-M₁) of platinum (Pt) and a first heterometal (M₁) to a reducing solvent, preparing a second mixture by adding a platinum precursor and a second heterometal (M₂) precursor to the first mixture, forming a first shell portion by simultaneously reducing platinum (Pt) and a second heterometal (M₂) on at least a portion of a surface of the alloy catalyst (Pt-M₁) by heating the second mixture, and forming a second shell portion by removing the second heterometal (M₂) from an outermost surface of the first shell portion by adding an intermediate catalyst including the alloy catalyst (Pt-M₁) and the first shell portion to an acid solution followed by acid treatment.

In some embodiments, the method of present disclosure may include, the first heterometal (M₁) comprises at least two different metallic elements (M₁₋₁, M₁₋₂ . . . ), preparing a first sub mixture by adding a platinum (Pt) and a first heterometal (M₁₋₁) alloy catalyst (Pt-M₁₋₁) to a reducing solvent; preparing a second sub mixture by adding a precursor of a second heterometal (M₁₋₂) to the first sub mixture; and heating the second sub mixture to produce a platinum (Pt) and first and second heterometal (M₁₋₁, M₁₋₂) alloy catalyst (Pt-M₁).

In some embodiments, the reducing solvent may include any one selected from the group consisting of dimethylformamide (DMF), oleylamine, dodecylamine, ethylene glycol, ascorbic acid, and combinations thereof.

In some embodiments, the alloy catalyst (Pt-M₁) may be added to a concentration of 5 g/L to 20 g/L based on a volume of the reducing solvent.

In some embodiments, the platinum precursor may be added to the first mixture in a ratio of 0.1 to 0.5 moles relative to moles of the alloy catalyst (Pt-M₁).

In some embodiments, the second heterometal (M₂) precursor may be added to the first mixture so that the amount of the second heterometal (M₂) is 0.03 to 10 wt % based on the total weight of the triple core-shell catalyst complex.

In some embodiments, the platinum precursor may include any one selected from the group consisting of chloroplatinic acid, platinum acetylacetonate, platinum chloride, platinum bromide, platinum iodide, and combinations thereof.

In some embodiments, the second heterometal (M₂) precursor may include a compound in which the second heterometal (M₂) is attached to any one functional group selected from the group consisting of acetylacetonate, chloride, bromide, iodide, and combinations thereof.

In some embodiments, the acid solution may include any one selected from the group consisting of hydrochloric acid, sulfuric acid, nitric acid, perchloric acid, and combinations thereof.

In some embodiments, the intermediate catalyst may be added to a concentration of 1 g/L to 20 g/L based on a volume of the acid solution.

In some embodiments, the acid treatment may include heating at a temperature of 30° C. to 100° C. for 1 to 10 hours after adding the intermediate catalyst to the acid solution.

In some embodiments, the method may further include stabilizing the second shell portion by heat treatment, after forming the second shell portion.

In some embodiments, the heat treatment may be performed in an inert atmosphere or a reducing atmosphere.

In some embodiments, the heat treatment may be performed at a temperature of 150° C. to 450° C.

As discussed, the method and system suitably include use of a controller or processer.

In another embodiment, vehicles are provided that comprise an apparatus as disclosed herein.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a triple core-shell catalyst complex according to some embodiments of the present disclosure in which a triple core-shell catalyst is supported on a support,

FIG. 2A schematically shows a process of manufacturing a triple core-shell catalyst complex according to some embodiments of the present disclosure,

FIG. 2B schematically shows a process for manufacturing a triple core-shell catalyst complex according to some embodiments of the present invention.

FIG. 3 shows a membrane-electrode assembly for an electrochemical device to which the triple core-shell catalyst complex according to some embodiments of the present disclosure is applied,

FIG. 4 shows a transmission electron microscope (TEM) image of a catalyst according to Example of the present disclosure,

FIG. 5 shows a TEM image of a catalyst according to Comparative Example 1 of the present disclosure,

FIG. 6 is a graph showing the particle size distribution of the catalyst according to Example of the present disclosure,

FIG. 7 is a graph showing the particle size distribution of the catalyst according to Comparative Example 1 of the present disclosure,

FIG. 8 shows high-angle annular dark-field-scanning transmission electron microscopy (HAADF-STEM) and energy dispersive spectroscopy (EDS) mapping images of the catalyst according to Example of the present disclosure,

FIG. 9 shows results of line scanning of the catalyst according to Example of the present disclosure using HAADF-STEM-EDS,

FIG. 10 shows results of X-ray diffraction (XRD) analysis of the catalysts according to Example and Comparative Example 1 of the present disclosure,

FIG. 11 is a graph showing voltage-current curves for membrane-electrode assemblies to which the catalysts according to Example, Comparative Example 1, and Comparative Example 2 of the present disclosure are applied,

FIG. 12 is a graph showing results of a durability test of membrane-electrode assemblies to which the catalysts according to Example and Comparative Example 1 of the present disclosure are applied, and

FIG. 13 is a comparative graph showing changes in durability obtained from FIG. 12.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

The term “core” herein refers to the central region of a nanoparticle, comprising a platinum alloy (Pt-M₁) in which the first heterometal M₁ is alloyed with platinum.

The term “first shell” herein refers to a layer at least partially covering the core.

The term “second shell” herein refers to a layer formed on at least a portion of the first shell.

The term “heterometal” herein refers to a metal element other than platinum.

The term “average particle diameter (D50)” herein refers to a median diameter of a population of catalyst particles, such that 50 percent by volume of the particles are smaller than that diameter, as determined by methods such as transmission electron microscopy (TEM) or dynamic light scattering (DLS).

The term “reducing solvent” herein refers to a solvent capable of chemically reducing metal precursors to their elemental form.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

### Triple Core-Shell Catalyst Complex for Electrochemical Device

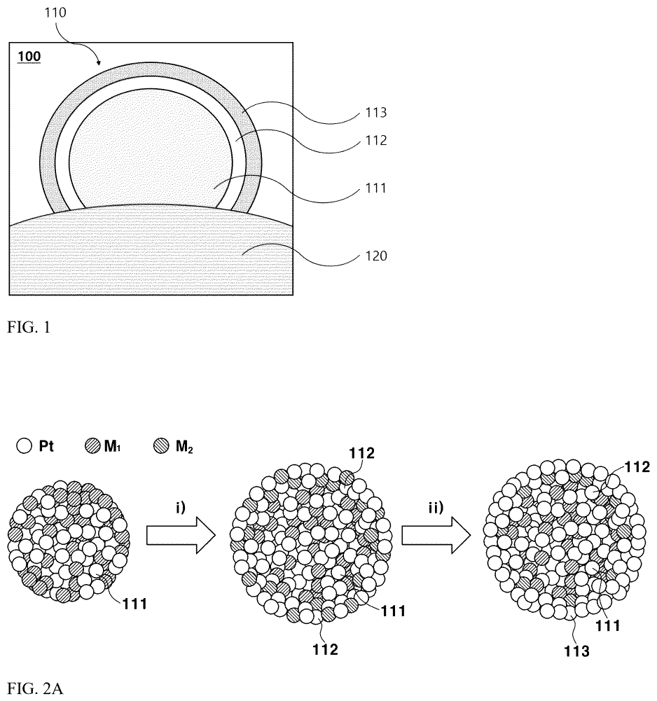

FIG. 1 shows a triple core-shell catalyst complex 100 for an electrochemical device according to the present disclosure in which a triple core-shell catalyst 110 is supported on a support 120.

The electrochemical device is a device that uses oxidation and reduction reactions and various phenomena caused by the transfer of electrons between materials, and a representative example thereof is a device based on fuel cell technology using a proton exchange membrane (PEM) and carbon dioxide reduction reaction (CO₂RR) technology for converting carbon dioxide into useful compounds by electrochemical reduction. The fuel cell to which the proton exchange membrane is applied and the device to which carbon dioxide reduction reaction technology is applied may use a catalyst or catalyst complex that is able to lower reaction activation energy in the process of inducing oxidation and reduction reactions.

Unless described otherwise below, a description will be based on cases where the triple core-shell catalyst complex according to the present disclosure is applied to the proton exchange membrane fuel cell, and the same effect may be obtained even when the catalyst complex according to the present disclosure is employed in the electrode of a device to which carbon dioxide reduction reaction technology is applied.

A triple core-shell catalyst 110 according to the present disclosure may include a core portion 111 including an alloy catalyst (Pt-M₁) of platinum (Pt) and a first heterometal (M₁), a first shell portion 112 covering at least a portion of a surface of the core portion 111 and including platinum (Pt) and a second heterometal (M₂), and a second shell portion 113 covering at least a portion of a surface of the first shell portion 112 and including platinum (Pt). As such, the triple core-shell catalyst 110 may be provided in a form supported on a support 120 as shown in FIG. 1.

The triple core-shell catalyst 110 according to the present disclosure has a triple core-shell structure including the core portion 111 including the alloy catalyst (Pt-M₁), the first shell portion 112 including platinum (Pt) and a second heterometal (M₂), and the second shell portion 113 including platinum (Pt), thereby exhibiting high oxygen reduction reaction activity by virtue of the alloy catalyst and effectively suppressing elution of the first heterometal (M₁) forming an alloy with platinum during operation of the fuel cell.

Therefore, the triple core-shell catalyst complex 100 according to the present disclosure is able to solve the problem of lowering the activity of the catalyst itself due to elution of the first heterometal (M₁) and the problem of adversely affecting durability of the fuel cell due to poisoning of the ionomer and electrolyte membrane by the eluted first heterometal (M₁).

The core portion 111 may include the alloy catalyst (Pt-M₁) as a main component. Here, the core portion 111 including the alloy catalyst (Pt-M₁) as a main component may mean that the weight of the alloy catalyst (Pt-M₁) included in the core portion 111 is greater than the weight of the second heterometal (M₂).

The first heterometal (M₁) is a metal element that plays a role in enhancing oxygen reduction reaction activity or improving elution durability by alloying with platinum (Pt) compared to when platinum is used alone as a catalyst. The first heterometal (M₁) may be applied without particular limitation, so long as it is able to provide electrons to platinum to perform the aforementioned function, thereby weakening binding strength between platinum and oxygen or inhibiting oxidation of platinum.

For example, the first heterometal (M₁) may include any one selected from the group consisting of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), bismuth (Bi), and combinations thereof.

Here, the phrase “may include any one selected from the group consisting of combinations thereof” may be understood to mean that the first heterometal (M₁) forming an alloy with platinum may include only one of the metallic elements or may include two or more different metallic elements (M₁₋₁, M₁₋₂, . . . ).

For example, when the first heterometal (M₁) is a single metallic element, the first alloy catalyst may be denoted as Pt-M₁ or Pt-M₁₋₁. In contrast, when the first heterometal (M₁) includes two or more different metallic elements, the first alloy catalyst may be denoted as Pt-M₁ or Pt-M₁₋₁M₁₋₂.

Moreover, the ratio of platinum to the first heterometal (M₁) in the alloy catalyst (Pt-M₁) is not particularly limited, and, for example, the weight ratio thereof may be freely chosen in the range of 50:1 to 1:50.

The first shell portion 112 including platinum (Pt) and a second heterometal (M₂) may be formed on at least a portion of the surface of the core portion 111. Preferably, the first shell portion 112 includes platinum (Pt) and a second heterometal (M₂) as main components. Here, the first shell portion 112 including platinum (Pt) and the second heterometal (M₂) as main components may mean that the weight of the second heterometal (M₂) included in the first shell portion 112 is greater than the weight of the first heterometal (M₁).

The platinum (Pt) and the second heterometal (M₂) of the first shell portion 112 are formed by simultaneous reduction of respective precursors thereof, for example, a platinum precursor and a second heterometal (M₂) precursor, and the second heterometal (M₂) does not change the crystal structure of platinum (Pt) or does not form a solid solution, and thus, it may be understood that the platinum (Pt) and the second heterometal (M₂) are reduced and deposited on the surface of the core portion 111 to form a thin first shell portion 112.

Also, the platinum (Pt) and the second heterometal (M₂) form a layer having an arbitrary thickness on the surface of the alloy catalyst (Pt-M₁) to suppress elution of the first heterometal (M₁), and thus may be distinguished from those that are doped by being discontinuously dispersed on the surface of the alloy catalyst (Pt-M₁).

Unless specified otherwise, the first shell portion 112 of the present specification means the first shell portion 112 in a state where acid treatment described below is performed and the second shell portion 113 is formed on the surface thereof.

Meanwhile, oxygen reduction reaction occurs in the process of attaching or detaching oxygen molecules to or from the surface of platinum. In order to more easily perform the process of attaching or detaching oxygen molecules, it is desirable that the binding strength of oxygen molecules attached to the surface of platinum be appropriately controlled so as not to be too strong or too weak. The Volcano plot is a graphical representation of oxygen reduction reaction depending on the binding strength between the platinum surface and oxygen.

The second heterometal (M₂) used in the present disclosure may be an element that may bring the platinum-oxygen binding strength of the alloy catalyst (Pt-M₁) closer to the peak of the Volcano plot of oxygen reduction reaction or may improve elution durability. As such, the closer the Volcano plot of alloy oxygen reduction reaction is to the peak, the more easily oxygen molecules may be attached to/detached from the surface of platinum, allowing oxygen reduction reaction to occur efficiently.

The second heterometal (M₂) is not particularly limited, so long as it is an element that may bring the platinum-oxygen binding strength of the alloy catalyst (Pt-M₁) closer to the peak of the Volcano plot of oxygen reduction reaction or may improve elution durability, and for example, the second heterometal (M₂) may include any one selected from the group consisting of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), bismuth (Bi) and combinations thereof. Preferably, the second heterometal (M₂) may include any one selected from the group consisting of zinc (Zn), gallium (Ga), molybdenum (Mo), indium (In), tin (Sn), iridium (Ir), gold (Au), and combinations thereof.

Also, it is preferable that the second heterometal (M₂) may include at least one metal element which different from the first heterometal (M₁) to bring the platinum-oxygen binding strength of the alloy catalyst (Pt-M₁) closer to the peak of the Volcano plot of oxygen reduction reaction. For example, when nickel (Ni) is used as the first heterometal (M₁), the second heterometal (M₂) may be gallium (Ga). In addition, when cobalt (Co) and gallium (Ga) are used as the first heterometal (M₁₋₁M₁₋₂), the second heterometal (M₂) may be gallium (Ga).

The second shell portion 113 including platinum (Pt) may be formed on at least a portion of the surface of the first shell portion 112. Preferably, the second shell portion 113 includes platinum (Pt) as a main component, and more preferably, the second shell portion 113 is composed of platinum (Pt). Here, the second shell portion 113 including platinum (Pt) as a main component may mean that the weight of platinum (Pt) included in the second shell portion 113 is greater than the weight of the other element, for example, the second heterometal (M₂).

Also, the second shell portion 113 may be derived from the first shell portion 112. The meaning that the second shell portion 113 is derived from the first shell portion 112 may be understood as the second shell portion 113 being formed by removing the second heterometal (M₂) from the outermost surface of the first shell portion 112 through acid treatment.

The second shell portion 113 according to the present disclosure may be provided in the form of a uniform platinum shell (i.e., second shell) on the outermost surface of the triple core-shell catalyst 110 as it is derived from the first shell portion 112. Accordingly, the first heterometal (M₁) may be more effectively prevented from elution outside the catalyst.

In some embodiments, the average particle diameter D50 of the triple core-shell catalyst 110 may be 2 nm to 11 nm, preferably 3.5 nm to 6.0 nm. The triple core-shell catalyst 110 according to the present disclosure may have such a nanoparticle size, exhibiting high catalytic activity. If the average particle diameter of the triple core-shell catalyst 110 is less than 2 nm, synthesis thereof is difficult, whereas if it exceeds 11 nm, activity of the catalyst may decrease.

In some embodiments, the thickness of the first shell portion 112 may be 0.1 nm to 1 nm, and the thickness of the second shell portion 113 may be 0.2 nm to 3 nm. Preferably, the thickness of the second shell portion 113 is 0.2 nm to 1.5 nm.

The triple core-shell catalyst 110 according to the present disclosure may have little effect on the overall particle size as compared to the alloy catalyst (Pt-M₁) in which no shell portion is formed, because the first shell portion 112 and the second shell portion 113 are formed at low thicknesses on the surface of the alloy catalyst (Pt-M₁) and the surface of the first shell portion 112, respectively. Accordingly, it is possible to exhibit high oxygen reduction reaction activity and also to effectively suppress elution of the first heterometal (M₁).

If the thickness of the first shell portion 112 is too low, the second heterometal (M₂) may be doped too little, and the effect of improving electrochemical performance and durability due to the second heterometal (M₂) may not be sufficient, whereas if the thickness of the second shell portion 113 is too high, the effect of the alloy catalyst (Pt-M₁) may decrease due to an excess of second heterometal (M₂).

Also, if the thickness of the second shell portion 113 is too low, elution of the first heterometal (M₁) during operation of the fuel cell cannot be sufficiently suppressed, whereas if the thickness of the second shell portion 113 is too high (e.g., greater than 3 nm), the effect of improving performance of the catalyst due to the alloy catalyst (Pt-M₁) and the first shell portion 112 may decrease.

In some embodiments, the triple core-shell catalyst complex 100 may include 0.1 to 50 wt % of platinum (Pt) and 0.05 to 10 wt % of the first heterometal (M₁) based on the total weight thereof. Here, the amount of platinum (Pt) may indicate the amount of platinum (Pt) included in all of the core portion 111, the first shell portion 112, and the second shell portion 113. In some embodiments, the amount of the second heterometal (M₂) may be 0.03 to 10 wt % based on the total weight of the triple core-shell catalyst complex 100.

As such, the remainder other than the amounts of the platinum (Pt), the first heterometal (M₁), and the second heterometal (M₂) based on the total weight of the triple core-shell catalyst complex may be the amount of the support.

Meanwhile, the triple core-shell catalyst complex 100 may be provided in the form of a catalyst complex in which the triple core-shell catalyst 110 is supported on the support 120 as shown in FIG. 1. The support 120 may play a role in expanding the active area of the catalyst and improving stability by supporting the triple core-shell catalyst 110 on the surface thereof.

The support 120 is not particularly limited, so long as it is commonly used in the relevant technical field, and may include, for example, a carbon-based support and/or a metal oxide-based support. The carbon-based support may include any one selected from the group consisting of carbon black, carbon nanotubes, graphite, graphene, and combinations thereof. The carbon black may include acetylene black, Denka black, Ketjen black, etc.

The metal oxide-based support may include any one selected from the group consisting of ZrO₂, MgO, TiO₂, Al₂O₃, SiO₂, CrO₂, Fe₂O₃, Fe₃O₄, CuO, ZnO, CaO, Sb₂O₄, Co₃O₄, Fe₃O₄, Pb₃O₄, Mn₃O₄, Ag₂O₂, U₃O₈, CuzO, LizO, Rb₂O, Ag₂O, Tl₂O, BeO, CdO, TiO, GeO₂, HfO₂, PbO₂, MnO₂, TeO₂, SnO₂, La₂O₃, Fe₂O₃, CeO₂, WO₂, UO₂, ThO₂, TeO₂, MoO₃, and combinations thereof.

### Method of Manufacturing Triple Core-Shell Catalyst Complex for Electrochemical Device

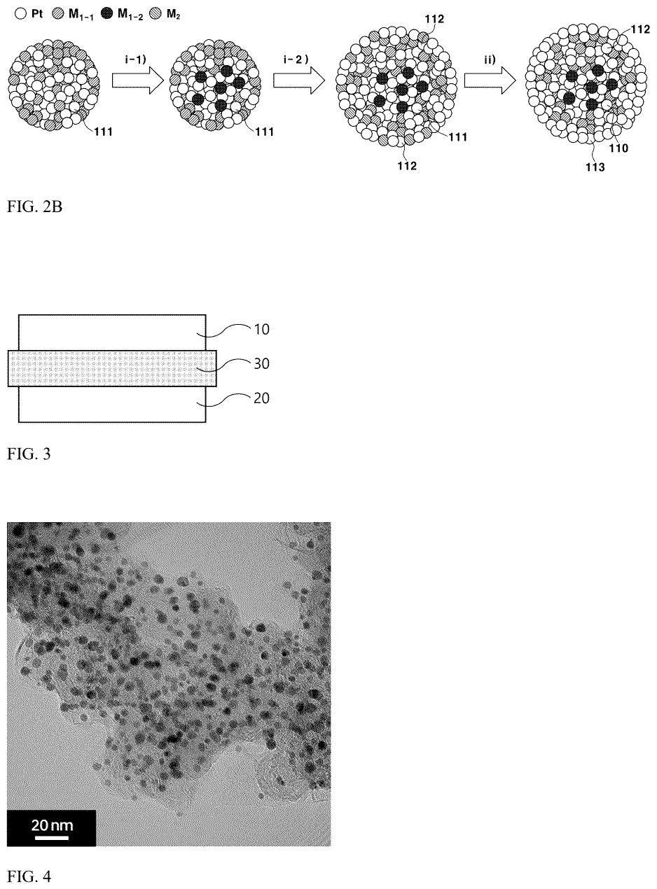

FIG. 2A schematically shows a process of manufacturing a triple core-shell catalyst complex for an electrochemical device according to the present disclosure. Here, for convenience of explanation, the triple core-shell catalyst 110 is illustrated as not being supported on a support, but it is of course possible for the triple core-shell catalyst 110 to be supported on a support.

A method of manufacturing a triple core-shell catalyst complex for an electrochemical device according to the present disclosure may include preparing a first mixture by adding an alloy catalyst (Pt-M₁) of platinum (Pt) and a first heterometal (M₁) to a reducing solvent, preparing a second mixture by adding a platinum precursor and a second heterometal (M₂) precursor to the first mixture, forming a first shell portion 112 by simultaneously reducing platinum (Pt) and a second heterometal (M₂) on at least a portion of the surface of the alloy catalyst (Pt-M₁) by heating the second mixture, and forming a second shell portion 113 by removing the second heterometal (M₂) from the outermost surface of the first shell portion 112 by adding an intermediate catalyst including the alloy catalyst (Pt-M₁) and the first shell portion 112 to an acid solution followed by acid treatment.

Below is a detailed description of individual steps.

First, an alloy catalyst (Pt-M₁) of platinum (Pt) and a first heterometal (M₁) may be added to a reducing solvent. The platinum (Pt) and first heterometal (M₁) alloy catalyst (Pt-M₁) may be obtained by purchasing a commercially available product or may be prepared by the following method.

Here, the first heterometal (M₁) of the alloy catalyst (Pt-M₁) added to the reducing solvent may include only one of the aforementioned metallic elements or may include two or more different metallic elements (M₁₋₁, M₁₋₂, . . . ).

FIG. 2B schematically illustrates a process for manufacturing a triple core-shell catalyst complex in a case where two kinds of metallic elements are used as the first heterometal (M₁) according to the present invention.

In some embodiments, the method of present disclosure may include, the first heterometal (M₁) comprises at least two different metallic elements (M₁₋₁, M₁₋₂ . . . ), preparing a first sub mixture by adding a platinum (Pt) and a first heterometal (M₁₋₁) alloy catalyst (Pt-M₁₋₁) to a reducing solvent; preparing a second sub mixture by adding a precursor of a second heterometal (M₁₋₂) to the first sub mixture; and heating the second sub mixture to produce a platinum (Pt) and first and second heterometal (M₁₋₁, M₁₋₂) alloy catalyst (Pt-M₁).

Although the above description has been made on the assumption that the first heterometal (M₁) includes two kinds of metallic elements, when the number of types of the first heterometal used to form an alloy with platinum increases, the above process may be repeated to prepare an alloy catalyst (Pt-M₁₋₁M₁₋₂M₁₋₃ . . . ).

In one embodiment, the precursor of the first heterometal (M₁) is not particularly limited as long as it can react in the reducing solvent to form an alloy with platinum.

For example, the precursor may include a compound in which the first heterometal (M₁) is bound to a functional group selected from the group consisting of an acetylacetonate group, a chloride group, a bromide group, an iodide group, and any combination thereof.

The reducing solvent has a low reducing power to simultaneously reduce platinum of the platinum precursor and the second heterometal (M₂) of the second heterometal (M₂) precursor on the surface of the alloy catalyst (Pt-M₁), and may include any one selected from the group consisting of, for example, DMF (dimethylformamide), oleylamine, dodecylamine, ethylene glycol, ascorbic acid, and combinations thereof.

In some embodiments, the alloy catalyst (Pt-M₁) may be added to a concentration of 5 g/L to 20 g/L based on the volume of the reducing solvent. Specifically, 5 to 20 g of the alloy catalyst (Pt-M₁) per L of the reducing solvent may be added. Preferably, the alloy catalyst (Pt-M₁) is added at a concentration of about 10 g/L to the reducing solvent.

Next, a platinum precursor and a second heterometal (M₂) precursor may be added to the first mixture.

The platinum precursor may be used without particular limitation, so long as it reacts in the reducing solvent and is reduced on the surface of the alloy catalyst (Pt-M₁) so that platinum may be deposited. The platinum precursor may include any one selected from the group consisting of, for example, chloroplatinic acid, platinum acetylacetonate, platinum chloride, platinum bromide, platinum iodide, and combinations thereof.

The platinum precursor may be added to the first mixture in a ratio of 0.1 to 0.5 moles relative to the moles of the alloy catalyst (Pt-M₁). If the amount of the platinum precursor that is added is less than 0.1 moles relative to the moles of the alloy catalyst (Pt-M₁), the first shell portion may not be formed thick enough, making it difficult to remove the second heterometal (M₂) from the outermost surface of the first shell portion and to form the second shell portion. On the other hand, if the amount of the platinum precursor that is added exceeds 0.5 moles relative to the moles of the alloy catalyst (Pt-M₁), the first shell portion may be formed too thick, which may hinder the effect of increasing activity by the alloy catalyst of the core portion, resulting in decreased catalytic activity. Also, some platinum is likely to grow on the surface of the support rather than on the surface of the alloy catalyst (Pt-M₁) to form new nanoparticles.

The second heterometal (M₂) precursor may be used without particular limitation, so long as it reacts in the reducing solvent and is reduced on the surface of the alloy catalyst (Pt-M₁) so that the second heterometal (M₂) may be deposited. For example, this precursor may include a compound in which the second heterometal (M₂) is attached to any one functional group selected from the group consisting of acetylacetonate, chloride, bromide, iodide, and combinations thereof. A more specific example thereof may include gallium acetylacetonate.

The second heterometal (M₂) precursor may be added to the first mixture so that the amount of the second heterometal (M₂) after reduction reaction is 0.03 to 10 wt % based on the total weight of the triple core-shell catalyst 110 complex.

After the second mixture is prepared by adding the platinum precursor and the second heterometal (M₂) precursor to the first mixture in this way, the second mixture may be heated. In the process of heating the second mixture, the platinum and the second heterometal (M₂) may be simultaneously reduced on the surface of the alloy catalyst (Pt-M₁), and the first shell portion 112 may be formed. The temperature to which the second mixture is heated may be about 120° C. to 200° C., preferably 160° C. to 180° C. Also, the heating time may be 6 hours to 72 hours, preferably about 48 hours.

If the temperature for heating the second mixture is too high or the heating time is too long, the first shell portion 112 may be formed too thickly on the surface of the alloy catalyst (Pt-M₁). On the other hand, if the temperature for heating the second mixture is too low or the heating time is too short, the first shell portion 112 may be formed too thinly on the surface of the alloy catalyst (Pt-M₁).

By simultaneously reducing platinum (Pt) and the second heterometal (M₂) on at least a portion of the surface of the alloy catalyst (Pt-M₁) by heating the second mixture in this way, a first shell portion 112 may be formed, and an intermediate catalyst including the alloy catalyst (Pt-M₁) and the first shell portion 112 before acid treatment may be obtained.

Meanwhile, before heating the second mixture, the second mixture may be dispersed using an ultrasonic disperser, or stirring may be performed together with heating to improve dispersibility of the second mixture, the reaction speed, and quality of the first shell portion 112.

Thereafter, acid treatment of the intermediate catalyst may be performed.

Specifically, the intermediate catalyst may be added to the acid solution followed by heating. In this process, the second heterometal (M₂) located on the outermost surface of the first shell portion 112 may be removed, and the second shell portion 113 may be formed.

The acid solution may include any one selected from the group consisting of hydrochloric acid, sulfuric acid, nitric acid, perchloric acid, and combinations thereof.

Also, the intermediate catalyst may be added to a concentration of 1 g/L to 20 g/L based on the volume of the acid solution. Specifically, 1 g to 20 g of the intermediate catalyst per L of the acid solution may be added. Preferably, the intermediate catalyst is added at a concentration of about 2 g/L.

In some embodiments, after adding the intermediate catalyst to the acid solution, acid treatment may be performed at a temperature of 30° C. to 100° C., preferably 40° C. to 80° C. Also, after heating, acid treatment may be performed for 1 to 10 hours, preferably about 2 hours.

If the acid treatment temperature is too low or the acid treatment time is too short, the second heterometal located on the outermost surface of the first shell portion 112 before acid treatment may not be properly removed. On the other hand, if the acid treatment temperature is too high or the acid treatment time is too long, the thickness of the second shell portion 113 may be greater than a desirable level, or in severe cases, the first shell portion 112 may be entirely converted into the second shell portion 113. After acid treatment, the product may be filtered and dried, obtaining a catalyst powder.

By removing the second heterometal (M₂) from the outermost surface of the first shell portion 112 before acid treatment by acid treatment of the intermediate catalyst in this way, a second shell portion 113 configured to cover at least a portion of the surface of the first shell portion 112 may be formed.

Meanwhile, after adding the intermediate catalyst to the acid solution and before heating, the acid solution containing the intermediate catalyst may be dispersed using an ultrasonic disperser, or stirring may be performed together with heating to improve the dispersibility of the intermediate catalyst, the reaction speed, quality of the second shell 113, etc.

In some embodiments, after forming the second shell portion 113 through acid treatment, stabilizing the second shell portion 113 by heat treatment of the triple core-shell catalyst 110 or the catalyst complex including the same may be further included. The platinum element of the second shell portion 113 may be rearranged through heat treatment of the triple core-shell catalyst 110 or the catalyst complex including the same, thereby increasing robustness of the catalyst. Accordingly, elution of the first heterometal (M₁) may be more effectively suppressed, durability of the catalyst may be improved, and performance and durability of the fuel cell may be further improved.

In some embodiments, heat treatment may be performed in an inert atmosphere or a reducing atmosphere. For example, the inert atmosphere may be formed by an inert gas such as nitrogen gas or a Group 18 element gas, and the reducing atmosphere may be formed by a reducing gas in which a small amount of hydrogen gas is mixed with the inert gas. In addition, any inert gas or reducing gas may be used without particular limitation, so long as it is commonly used in the relevant technical field.

In some embodiments, heat treatment may be performed at a temperature of 150° C. to 450° C., preferably 150° C. to 350° C. Also, heat treatment may be performed for 1 to 10 hours, preferably about 2 hours. If the heat treatment temperature is too high or the heat treatment time is too long, platinum nanoparticles of the second shell portion 113 may aggregate, increasing an average diameter thereof, whereas if the heat treatment temperature is too low or the heat treatment time is too short, the platinum element of the second shell portion 113 may not be sufficiently rearranged, and thus robustness of the catalyst 110 may not sufficiently increase.

For reference, the triple core-shell catalyst complex manufactured by the method of the present disclosure and each component included therein are substantially the same as those described in the “Triple core-shell catalyst complex” above, so a detailed description thereof will be omitted.

As described above, the triple core-shell catalyst complex 100 for an electrochemical device according to the present disclosure includes the triple core-shell catalyst 110 including the core portion 111 including the alloy catalyst (Pt-M₁), the first shell portion 112 including platinum (Pt) and the second heterometal (M₂), and the second shell portion 113 including platinum (Pt), thereby exhibiting high oxygen reduction reaction activity and effectively suppressing elution of the first heterometal (M₁).

Moreover, by performing acid treatment and heat treatment on the first shell portion 112, the second heterometal (M₂) may be removed from the outermost surface of the first shell portion, and the second shell portion 113 made of platinum (Pt) may be uniformly formed on the surface of the first shell portion 112, thereby more effectively suppressing elution of the metal during operation of the fuel cell, improving durability of the catalyst, and further improving performance and durability of the fuel cell.

### Membrane-Electrode Assembly

FIG. 3 shows a membrane-electrode assembly according to the present disclosure. The membrane-electrode assembly according to the present disclosure includes an electrolyte membrane 30, a cathode 10 formed on one surface of the electrolyte membrane 30, and an anode 20 formed on the remaining surface of the electrolyte membrane 30, and at least one of the cathode 10 or the anode 20 may include the triple core-shell catalyst complex 100 according to the present disclosure.

The anode 20 is an electrode that is supplied with fuel such as hydrogen gas so that hydrogen is separated into protons and electrons through hydrogen oxidation reaction (HOR) and is also called a fuel electrode.

The cathode 10 is an electrode that performs oxygen reduction reaction (ORR) of the protons moving from the anode 20 through the electrolyte membrane 30, electrons supplied from an external circuit, and oxygen gas supplied from the outside to generate power and heat and also produce water as a reaction byproduct, and is also called an oxygen electrode.

In the membrane-electrode assembly according to the present disclosure, an electrode for an electrochemical device to which the triple core-shell catalyst complex 100 according to the present disclosure is applied may be used as an anode 20 and/or a cathode 10, obtaining a fuel cell having excellent electrochemical performance and durability.

In addition, the electrolyte membrane 30 may be used without particular limitation, so long as it is commonly used in the present technical field. For example, a polymer (ionomer) with proton conductivity such as Nafion may be used. Also, an electrolyte membrane 30 in which a reinforced membrane such as e-PTFE is impregnated with the ionomer may be used.

A better understanding of the present disclosure may be obtained through the following example and comparative examples. However, these examples are not to be construed as limiting the technical spirit of the present disclosure.

### EXAMPLE

To manufacture a triple core-shell catalyst complex for an electrochemical device, a catalyst was synthesized through the following method.

First, an alloy catalyst was prepared in the form of an alloy of platinum (Pt) and nickel (Ni) supported on a carbon support (Stanford advanced materials; PT4939). The first mixture was prepared by adding the alloy catalyst to N,N-dimethylformamide (DMF) as a solvent. As such, 10 g of the alloy catalyst was added to 1 L of DMF for a concentration of 10 g/L.

The second mixture was prepared by adding platinum acetylacetonate as a platinum precursor and gallium acetylacetonate as a second heterometal precursor to the first mixture. As such, the platinum precursor added to the first mixture was used in 0.21 moles relative to the moles of the alloy catalyst metal (Pt—Ni), and the second heterometal precursor was added in an appropriate amount so that the amount of the second heterometal was 1.5 wt % based on the total weight of the triple core-shell catalyst complex according to Example.

The second mixture was dispersed for a sufficient time using an ultrasonic disperser and then heated with stirring. As such, the heating temperature was about 170° C. and the heating time was about 48 hours. After heating, the product was filtered and dried, obtaining an intermediate catalyst having a first shell portion formed on the surface of the alloy catalyst.

The intermediate catalyst thus obtained was added to 0.1 M perchloric acid. As such, 2 g of the intermediate catalyst was added to 1 L of perchloric acid for a concentration of 2 g/L. The acid solution containing the intermediate catalyst was sufficiently dispersed by ultrasonic treatment and then heated with stirring. As such, the heating temperature was about 60° C. and the heating time was about 2 hours. After heating, the product was filtered and dried, obtaining a catalyst powder having a first shell portion and a second shell portion formed on the surface of the alloy catalyst.

Thereafter, the catalyst powder was heated to about 300° C. at a rate of 3° C./min in a reducing atmosphere (3% H₂/Ar) followed by heat treatment for 2 hours, thereby obtaining a triple core-shell catalyst complex according to Example.

### Comparative Example 1

An alloy catalyst in the form of an alloy of platinum (Pt) and nickel (Ni) supported on a carbon support was prepared as a catalyst complex according to Comparative Example 1 (Stanford advanced materials; PT4939).

### Comparative Example 2

An alloy catalyst was prepared in the form of an alloy of platinum (Pt) and nickel (Ni) supported on a carbon support (Stanford advanced materials; PT4939). The first mixture was prepared by adding the alloy catalyst to N,N-dimethylformamide (DMF) as a solvent. As such, 10 g of the alloy catalyst was added to 1 L of DMF for a concentration of 10 g/L.

A second mixture was prepared by adding platinum acetylacetonate as a platinum precursor, gallium acetylacetonate as a second heterometal precursor, and nickel acetate (Ni(acac)₂) as a nickel precursor to the first mixture. As such, the platinum precursor added to the first mixture was used in 0.21 moles relative to the moles of the alloy catalyst metal (Pt—Ni), and the second heterometal precursor was added in an appropriate amount so that the amount of the second heterometal was 1.5 wt % based on the total weight of the catalyst complex according to Comparative Example 2.

In addition, a catalyst complex according to Comparative Example 2 was prepared in the same manner as in Example, with the exception that acid treatment and heat treatment were not performed on the intermediate catalyst.

### Test Example 1—TEM Analysis and Particle Size Distribution Analysis

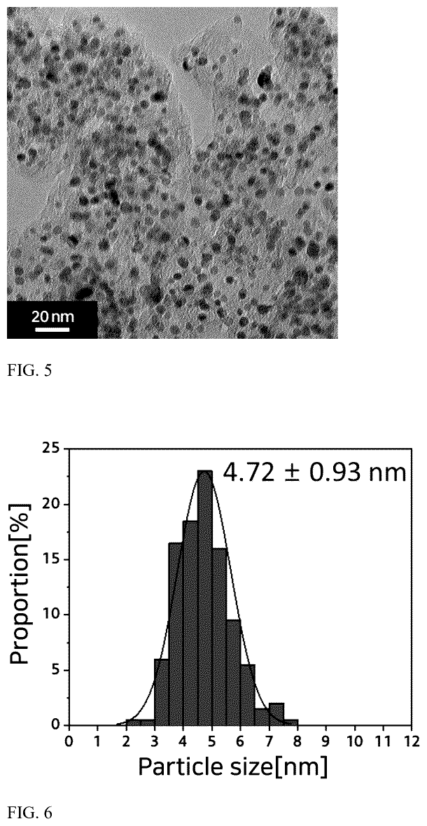

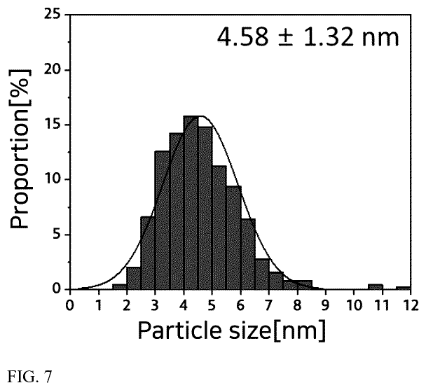

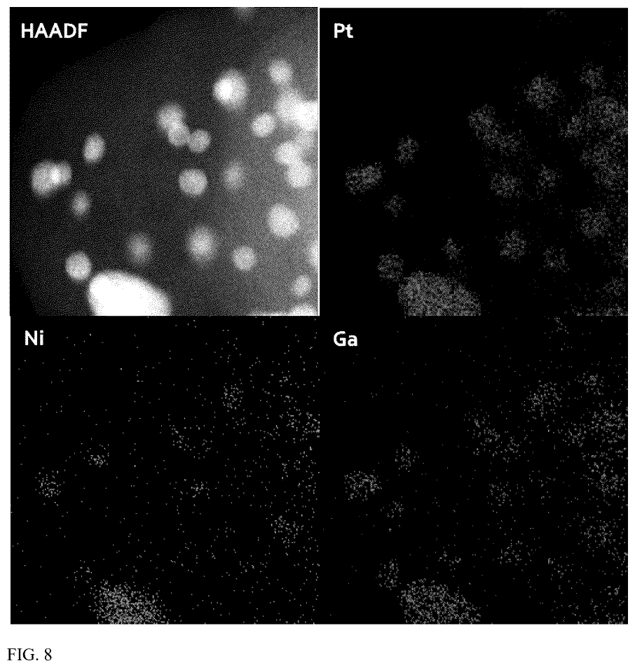

To confirm the structure and particle size of the synthesized catalyst, the catalyst complex according to Example and the catalyst complex according to Comparative Example 1 were photographed using a transmission electron microscope (TEM), and respective images thereof are shown in FIGS. 4 and 5. In addition, the particle size distributions of the triple core-shell catalysts were analyzed from the above results and are shown in FIGS. 6 and 7.

Referring to the results of FIGS. 4 and 6 for Example and FIGS. 5 and 7 for Comparative Example 1, the shape of the nanoparticles was maintained even after the first shell portion and the second shell portion were formed on the surface of the Pt—Ni/C catalyst, and the particle sizes were similar, with 4.72±0.93 nm in Example and 4.58±1.32 nm in Comparative Example 1.

### Test Example 2—HAADF-STEM and EDS Mapping Image

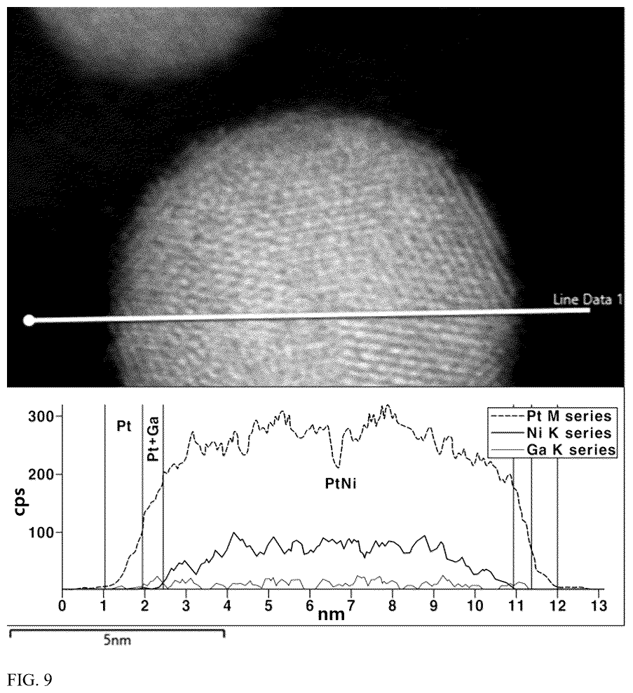

To confirm the composition of the triple core-shell catalyst according to Example, the catalyst according to Example was analyzed by high-angle annular dark-field scanning transmission electron microscopy (HAADF-STEM) and energy dispersive spectroscopy (EDS), and the mapping images thereof are shown in FIG. 8.

Referring to FIG. 8, the triple core-shell catalyst of the catalyst complex according to Example was confirmed to include nanoparticles in which platinum (Pt), nickel (Ni), and gallium (Ga) were present together.

In addition, to determine the structure of the catalyst complex according to Example, the triple core-shell catalyst of the catalyst complex was line-scanned using HAADF-STEM-EDS. FIG. 9 shows the line-scanned portion of the catalyst and results thereof.

Referring to FIG. 9, platinum (Pt) and nickel (Ni) were mainly observed in the center of the catalyst, platinum (Pt) and gallium (Ga) were observed therearound, and only platinum (Pt) was observed in the outermost surface. Thereby, the catalyst according to Example was confirmed to be a triple core-shell catalyst including a core portion including a Pt—Ni alloy catalyst, a first shell portion formed on the surface of the core portion and including Pt and Ga, and a second shell portion formed on the surface of the first shell portion and including Pt.

Here, the thickness of the first shell portion was determined to be about 0.5 nm, and the thickness of the second shell portion was determined to be about 1 nm.

### Test Example 3—XRD Analysis

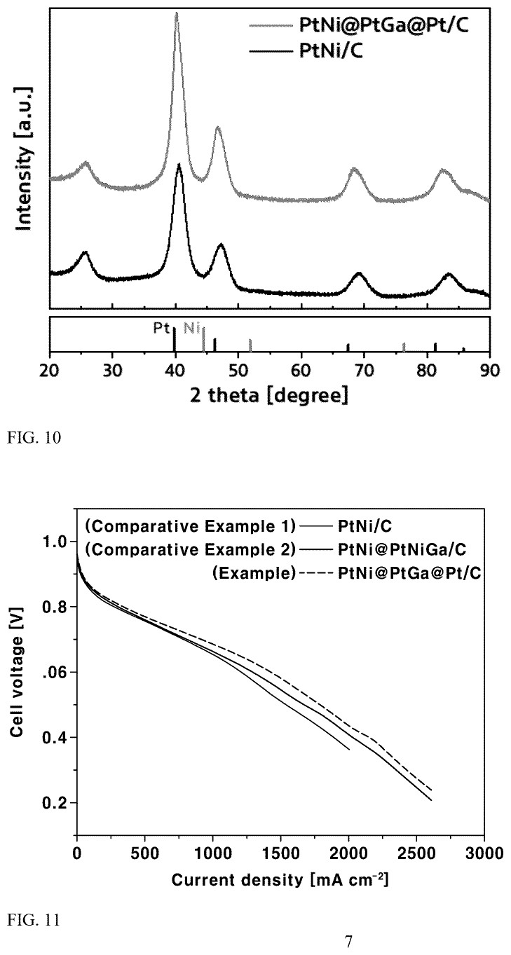

To determine whether there is a change in the crystal structure before and after forming the triple core-shell, XRD analysis was performed on the catalysts according to Example and Comparative Example 1, and the results thereof are shown in FIG. 10.

Referring to FIG. 10, it was confirmed that there was no change in the crystal structure before and after forming a two-layer shell on the surface of the Pt—Ni/C catalyst, as the positions and intensities of the peaks observed were similar. This shows that PtGa or Ga did not form nanoparticles separately but were formed by being very thinly doped on the surface of Pt—Ni/C nanoparticles located in the existing core portion.

### Manufacture of Membrane-Electrode Assembly

To verify performance of the manufactured catalyst, a membrane-electrode assembly was manufactured using the following method.

A cathode slurry was prepared by adding the triple core-shell catalyst according to Example and Nafion (D2021) as an electrode binder to a mixed solvent of 100 g of NPA (n-propyl alcohol) and 100 g of water. As such, the weight ratio of the catalyst to the electrode binder was set such that the weight of the carbon support in the triple core-shell catalyst and the weight of the Nafion were 1:0.8.

In addition, an anode slurry was prepared by adding a known Pt/C catalyst and Nafion (D2021) as an electrode binder to the mixed solvent. As such, the weight ratio of the Pt/C catalyst to the electrode binder was set such that the weight of the carbon support of the Pt/C catalyst and the weight of the Nafion were 1:1.

The cathode slurry was applied onto one surface of a known Nafion (211) electrolyte membrane and the anode slurry was applied onto the remaining surface thereof, followed by drying and heat treatment, thereby manufacturing a membrane-electrode assembly including a cathode (oxygen electrode), an anode (hydrogen electrode), and an electrolyte membrane disposed therebetween. As such, the catalyst loading on the cathode was set to 0.15 mgPt/cm², and the catalyst loading on the anode was set to 0.05 mgPt/cm².

For the catalysts according to Comparative Examples 1 and 2, respective membrane-electrode assemblies were manufactured by applying the catalysts to the cathode in the same manner as above.

### Test Example 4—Verification of Electrochemical Performance of Membrane-Electrode Assembly

In order to verify electrochemical performance of the membrane-electrode assemblies to which Example and Comparative Examples 1 and 2 were applied, after performing a charge/discharge experiment from low current density (0 A/cm²) to high current density (about 2.5 A/cm² to 3 A/cm²) by keeping the current constant and recording the voltage when the voltage stabilized, the voltage-current curves thereof are shown in FIG. 11.

Referring to FIG. 11, performance of the membrane-electrode assembly, in which the catalyst according to Comparative Example 2 in which gallium (Ga) was doped while maintaining the ratio of platinum (Pt) and nickel (Ni) was applied to the surface of the catalyst according to Comparative Example 1, was higher than that to which Comparative Example 1 was applied. Thereby, it was confirmed that gallium (Ga) present on the surface of the alloy catalyst plays a role in improving performance of a polymer electrolyte membrane fuel cell.

In addition, in Example in which the second shell portion composed of platinum (Pt) was additionally formed after doping the surface of the alloy catalyst with gallium (Ga), electrochemical performance was higher than that of the membrane-electrode assembly to which Comparative Example 2 was applied. Therefore, it was confirmed that designing catalyst nanoparticles with a triple core-shell structure as in the present disclosure is a strategy capable of further improving the performance of polymer electrolyte membrane fuel cells.

### Test Example 5—Verification of Durability of Membrane-Electrode Assembly

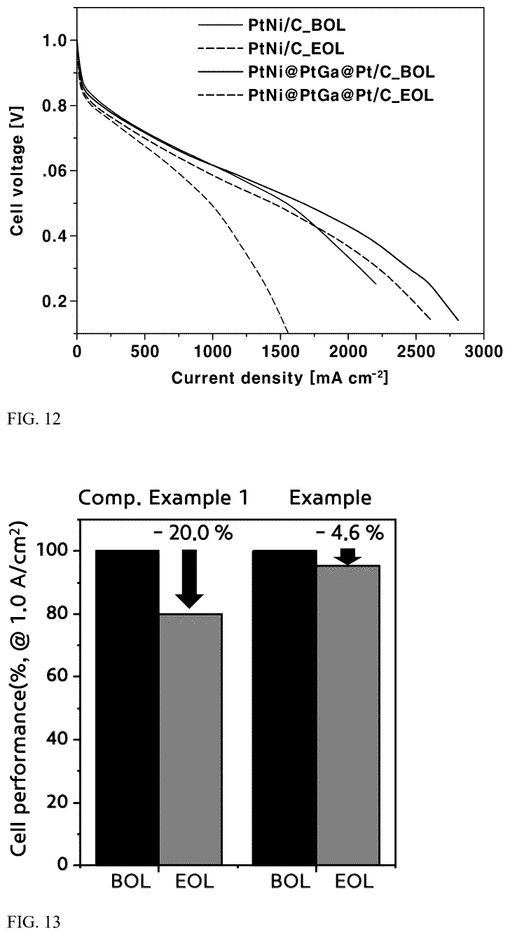

In order to verify durability of the membrane-electrode assemblies according to Example and Comparative Example 1, the manufactured membrane-electrode assembly was fastened at a pressure of 100 In*lb using a gasket made of Teflon and a bipolar plate made of carbon to form a unit cell, after which an accelerated degradation test (ADT) was performed under the following conditions, and the results thereof are shown in FIGS. 12 and 13.

ADT conditions: 0.6 V-0.95 V square wave 3 seconds, 10,000 times; environmental conditions: RH 100%, 65° C., 1.0 bara, AN:H₂ 42 sccm CA:N₂ 134 sccm.

Referring to the results of FIGS. 12 and 13, the durability of the cell to which the catalyst according to Example was applied was superior to that of the cell to which the catalyst according to Comparative Example 1 was applied. Thereby, it was confirmed that, when forming a first shell portion including platinum (Pt) and gallium (Ga) on the surface of the alloy catalyst and additionally forming a second shell portion composed of platinum (Pt) on the surface of the first shell portion as in the present disclosure, not only was there an improvement in electrochemical performance, but also elution of the first heterometal (M₁) was prevented, contributing to an improvement in durability of the fuel cell.

As is apparent from the foregoing, a triple core-shell catalyst for an electrochemical device according to the present disclosure includes a core portion including an alloy catalyst (Pt-M₁), a first shell portion including platinum (Pt) and a second heterometal (M₂), and a second shell portion including platinum (Pt), thereby exhibiting high oxygen reduction reaction activity and effectively suppressing elution of the first heterometal.

In addition, by performing acid treatment and heat treatment on the first shell portion, the second heterometal (M₂) is removed from the outermost surface of the first shell portion, and the second shell portion made of platinum (Pt) is uniformly formed on the surface of the first shell portion, whereby elution of the metal during operation of the electrochemical device can be more effectively suppressed, durability of the catalyst can be improved, and performance and durability of the fuel cell can be further improved.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A triple core-shell catalyst complex for an electrochemical device, comprising a triple core-shell catalyst comprising:
a core comprising an alloy catalyst (Pt-M₁) of platinum (Pt) and a first heterometal (M₁);
a first shell covering at least a portion of a surface of the core and comprising platinum (Pt) and a second heterometal (M₂); and
a second shell covering at least a portion of a surface of the first shell and comprising platinum (Pt).

2. The triple core-shell catalyst complex of claim 1, further comprising a support on which the triple core-shell catalyst is supported.

3. The triple core-shell catalyst complex of claim 1, wherein the first heterometal (M₁) comprises any one selected from the group consisting of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), bismuth (Bi), and combinations thereof, and
wherein the second heterometal (M₂) comprises any one selected from the group consisting of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), bismuth (Bi) and combinations thereof.

4. The triple core-shell catalyst complex of claim 3, wherein the first heterometal (M₁) comprises at least two different metallic elements (M₁₋₁, M₁-2, . . . ).

5. The triple core-shell catalyst complex of claim 1, wherein the first heterometal (M₁) and the second heterometal (M₂) comprises at least one metal element different from each other.

6. The triple core-shell catalyst complex of claim 1, wherein an average particle diameter (D50) of the triple core-shell catalyst is about 3.5 nm to 6 nm.

7. The triple core-shell catalyst complex of claim 1, wherein a thickness of the first shell is 0.1 nm to 1 nm, and a thickness of the second shell is about 0.2 nm to 1.5 nm.

8. The triple core-shell catalyst complex of claim 1, comprising about 0.1 to 50 wt % of the platinum (Pt) and about 0.05 to 10 wt % of the first heterometal (M₁), based on a total weight of the triple core-shell catalyst complex.

9. The triple core-shell catalyst complex of claim 1, comprising about 0.03 to 10 wt % of the second heterometal (M₂), based on a total weight of the triple core-shell catalyst complex.

10. A catalyst comprising:
a core comprising an alloy catalyst (Pt-M₁) of platinum (Pt) and a first heterometal (M₁);
an inner shell disposed on at least a portion of a surface of the core and comprising platinum (Pt) and a second heterometal (M₂); and
a Pt outer shell disposed on at least a portion of a surface of the inner shell.
wherein the first heterometal (M₁) comprises any one selected from the group consisting of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), bismuth (Bi), and combinations thereof, and
wherein the second heterometal (M₂) comprises any one selected from the group consisting of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), bismuth (Bi), and combinations thereof.

11. The catalyst of claim 10, wherein an average particle diameter (D50) of the catalyst is about 3.5 nm to 6 nm, wherein a thickness of the inner shell is about 0.1 nm to 1 nm, and a thickness of the outer shell is about 0.2 nm to 1.5 nm.

12. A method of manufacturing a triple core-shell catalyst complex for an electrochemical device, the method comprising:
preparing a first mixture by adding an alloy catalyst (Pt-M₁) of platinum (Pt) and a first heterometal (M₁) to a reducing solvent;
preparing a second mixture by adding a platinum precursor and a second heterometal (M₂) precursor to the first mixture;
forming a first shell by simultaneously reducing platinum (Pt) and a second heterometal (M₂) on at least a portion of a surface of the alloy catalyst (Pt-M₁) by heating the second mixture; and
forming a second shell by removing the second heterometal (M₂) from an outermost surface of the first shell by adding an intermediate catalyst comprising the alloy catalyst (Pt-M₁) and the first shell to an acid solution followed by acid treatment.

13. The method of claim 12,
wherein the first heterometal (M₁) comprises at least two different metallic elements (M₁₋₁, M₁₋₂ . . . ),
preparing a first sub mixture by adding a platinum (Pt) and a first heterometal (M₁₋₁) alloy catalyst (Pt-M₁₋₁) to a reducing solvent;
preparing a second sub mixture by adding a precursor of a second heterometal (M₁₋₂) to the first sub mixture; and
heating the second sub mixture to produce a platinum (Pt) and first and second heterometal (M₁₋₁, M₁₋₂) alloy catalyst (Pt-M₁).

14. The method of claim 12, wherein the reducing solvent comprises any one selected from the group consisting of dimethylformamide (DMF), oleylamine, dodecylamine, ethylene glycol, ascorbic acid, and combinations thereof.

15. The method of claim 12, wherein the platinum precursor is added to the first mixture in a ratio of about 0.1 to 0.5 moles relative to moles of the alloy catalyst (Pt-M₁).

16. The method of claim 12, wherein the second heterometal (M₂) precursor is added to the first mixture so that an amount of the second heterometal (M₂) is about 0.03 to 10 wt % based on a total weight of the triple core-shell catalyst complex.

17. The method of claim 12, wherein the platinum precursor comprises any one selected from the group consisting of chloroplatinic acid, platinum acetylacetonate, platinum chloride, platinum bromide, platinum iodide, and combinations thereof, and
wherein the second heterometal (M₂) precursor comprises a compound in which the second heterometal (M₂) is attached to any one functional group selected from the group consisting of acetylacetonate, chloride, bromide, iodide, and combinations thereof.
M₂M₂

18. The method of claim 12, wherein the acid treatment comprises heating at a temperature of about 30° C. to 100° C. for about 1 to 10 hours after adding the intermediate catalyst to the acid solution.

19. The method of claim 12, further comprising stabilizing the second shell by heat treatment, after forming the second shell.

20. The method of claim 19, wherein the heat treatment is performed in an inert atmosphere or a reducing atmosphere, and/or at a temperature of about 150° C. to 450° C.
